(19) United States
(12) Patent Application Publication
(10) Pub. No.: US 2005/0132336 A1
(43) Pub. Date: Jun. 16, 2005

(54) Analyzing software performance data using hierarchical models of software structure

(75) Inventors: Jacob K. Gotwals, Albuquerque, NM (US); Suresh Srinivas, Portland, OR (US)

Correspondence Address: VENABLE, BAETJER, HOWARD AND CIVILETTI, LLP, P.O. BOX 34385, WASHINGTON, DC, 20043-9998, US

(73) Assignee: Intel Corporation, Santa Clara, CA (US)

(21) Appl. No.: 10/735,855

(22) Filed: Dec. 16, 2003

(51) Int. Cl. G06F 9/44; G06F 11/30; G06F 15/00; G21C 17/00

(52) U.S. Cl. 717/127; 702/182

(57) ABSTRACT

Analyzing profile data of a software application in terms of high-level instances of the software application.

### BACKGROUND OF THE INVENTION

“Statistical sampling” and “call graph profiling” are software performance profiling methods currently used by software performance optimization tools such as the Intel® VTune™ Performance Analyzer, to enable software developers to identify the parts of a software system to focus on for performance optimization, and to identify the types of software modifications that will improve performance.

Current methods and systems for visualizing and interpreting performance data collected use statistical sampling and call graph profiling. The statistical sampling profiling method may be system-wide—it may measure the impact of all software components running on the system that may affect an application's performance. Statistical sampling has low measurement overhead, and there is no need to modify the application to facilitate the performance measurement. A method commonly used for analyzing statistical samples allows the user to progressively filter and partition the data by the units of abstraction available through operating system, compiler, and managed runtime environment (MRTE) mechanisms, and to view the resulting data in the form of charts and sortable tables. Expert systems may also be used to analyze sampled performance data and give advice for improving performance.

The call graph profiling method may give detailed information about the flow chart of control within an application. It may identify where and how often program control transitions from one function (section of an application) to another, how much time is spent executing the code in each function, and how much time is spent waiting for control to return to a function after a transition. A method commonly used for visualizing and analyzing call graph data is to allow the user to view profile statistics in hierarchical tables and graphical visualizations, where (as in the current sampling method) the units of abstraction within which the user may view the profile data are those available through operating system, compiler, and MRTE mechanisms.

Current software applications are becoming larger and more complex, often consisting of multiple software layers and subsystems. In addition, applications often involve many software components and layers outside of the application, including operating system (OS) and MRTE layers. The increasing complexity of software applications and of the software environments in which they run lead to limitations on the methods described above.

For example, current methods make it very hard for the user to understand application performance in terms of the high-level abstractions, such as applications, subsystems, layers, frameworks, managed runtime environments, operating systems, etc. As described above, profile data may only be analyzed in units of abstraction available through OS, compiler, and MRTE mechanisms. Often there is no simple one-to-one correspondence between these low-level abstractions and the high-level abstractions with which software developers comprehend today's complex software systems. Furthermore, current methods provide a challenge for mapping the instance names used by the performance tool to the high-level instances to which they belong.

One of the most important tasks made difficult by current methods is simply getting a high-level view of an application's performance in terms of high-level abstractions. This task is important both for large applications, and to understand the performance of smaller applications in relation to other layers.

Many current applications also run in the context of an increasingly complex hardware environment. When an application spans multiple computers (and thus multiple OS and MRTE instances), the number of low-level instances the user needs to deal with to understand performance increases, and understanding performance in terms of high-level abstractions becomes even more problematic.

Current methods also limit interactions and usage flow between or among multiple performance tools. Current performance tuning environments often involve multiple tools that support different profiling methods. Without a common framework of high-level abstractions to unify data across multiple tools, these differences in low-level abstractions may make it difficult for the user to correlate profile data from one tool to another, and may make it difficult for tool developers to design effective usage flow chart between tools.

Other useful tasks that may be difficult include analyzing profile data corresponding specifically to a given high-level abstraction, comparing the performance characteristics of multiple high-level instances involved in an application workload run, and understanding changes in performance characteristics of high-level instances in multiple workload runs. Current methods support comparisons of low-level instances like processes and modules, but comparison of high-level instances like layers and subsystems is generally not possible.

These limitations affect not only the user, but also expert systems (within the optimization tool) that interpret profile data. In current methods, these expert systems may only interpret data in terms of the same low-level units of abstraction available to the user. This limits the effectiveness of the expert systems in two ways. First, the expert system may not give advice summarizing the performance of particular layers, subsystems, and components because it has no knowledge of these high-level instances. Second, knowledge specific to high-level abstractions may not be expressed within the knowledge databases on which the expert systems' advice is based.

### BRIEF DESCRIPTION OF THE DRAWINGS

Various exemplary features and advantages of embodiments of the invention will be apparent from the following, more particular description of exemplary embodiments of the present invention, as illustrated in the accompanying drawings wherein like reference numbers generally indicate identical, functionally similar, and/or structurally similar elements.

FIG. 1 depicts an exemplary embodiment of a model according to the invention;

FIG. 2 depicts an exemplary embodiment of a system according to the invention;

FIG. 3 depicts an exemplary embodiment of a method according to the invention;

FIG. 4 depicts an exemplary embodiment of a method according to the invention;

FIG. 5 depicts an exemplary embodiment of a method according to the invention;

FIG. 6 depicts an exemplary embodiment of a method according to the invention;

FIG. 7 depicts an exemplary embodiment of a method according to the invention;

FIG. 8 depicts an exemplary embodiment of a method according to the invention;

FIG. 9 depicts an exemplary embodiment of a method according to the invention;

FIG. 10 depicts an exemplary embodiment of a method according to the invention;

FIG. 11 depicts an exemplary embodiment of an architecture view according to the invention;

FIG. 12 depicts an exemplary embodiment of a hierarchical view according to the invention;

FIG. 13 depicts an exemplary embodiment of a method according to the invention; and

FIG. 14 depicts an exemplary embodiment of a computer and/or communications system as can be used for several components in an exemplary embodiment of the invention.

### DETAILED DESCRIPTION OF EXEMPLARY EMBODIMENTS OF THE PRESENT INVENTION

Exemplary embodiments of the invention are discussed in detail below. While specific exemplary embodiments are discussed, it should be understood that this is done for illustration purposes only. A person skilled in the relevant art will recognize that other components and configurations may be used without parting from the spirit and scope of the invention.

Exemplary embodiments of the present invention may enable performance tools to analyze profile data in terms of high-level units of abstraction such as, e.g., applications, subsystems, layers, frameworks, managed runtime environments, operating systems, etc. Further, exemplary embodiments of the present invention may provide an improved system and method for mapping profile data to units of abstraction.

In an exemplary embodiment of the invention, a model structure may be used to define, for example, a set of high-level abstractions, a set of named instances of those abstractions, and a mapping between each high-level instance and a set of profile data that may be specified in terms of low level instances (whose mapping to profile data may be obtained by the performance tool via compiler, operating system (OS) or managed runtime environment (MRTE) mechanisms), or in terms of other high-level instances whose mappings have already been defined.

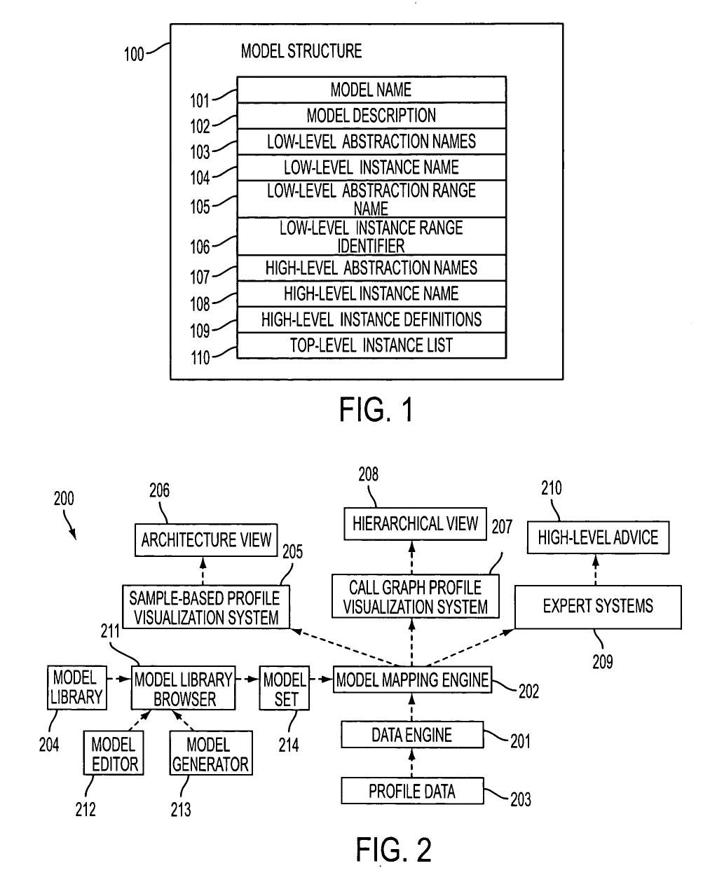

FIG. 1 illustrates an exemplary embodiment of a model structure 100 according to the present invention. Model structure 100 may be a data structure and may include, for example, model name 101, model description 102, low-level abstraction names 103, low-level instance name 104, low-level abstraction range name 105, low-level instance range identifier 106, high-level abstraction names 107, high level instance name 108, high-level instance definitions 109, and top-level instance list 110.

Model name 101 may be a short sequence of textual characters (a “string”) that gives an intuitive name corresponding to a software environment that the model represents. Examples of model names 100 may include, but are not limited to: “OS 101 ”, “ABC Printer V.1.0”, “XYZ Application”, and “My Application”.

Model description 102 may be a longer string than model name 101 and may describe the model in more detail. Examples of model description 101 may include, but are not limited to: “Models the structure of XYZ Application”, “Models the layers and subsystems within My Application”.

Low-level abstraction names 103 may be an enumeration (i.e., a list of named literal values) that lists the low-level abstractions to which the performance tool may be able to map profile data via compiler, OS, and MRTE mechanisms. This enumeration may, for example, consist of the following values: “process”, “thread”, “module”, “class”, “function”, “source file”, “relative virtual address”, and “node”. In an exemplary embodiment of the invention, the low-level abstraction names 103 may not be data elements within the model data structure, but instead may be a set of fixed constants used to define other elements within the data structure.

Low-level instance name 104 may be a data element that identifies an instance of a low-level abstraction in terms of the way that abstraction is identified by the compiler, OS, or MRTE. Examples of a low-level instance name 104 may include, but are not limited to: (class) “java.io.File”, (module) “vtundemo.exe”. In an exemplary embodiment of the invention, a low-level instance name 104 may be used within high-level instance definitions 109 discussed below. Further, in the case of processes, threads, etc., the performance tool may support an application programming interface (API) that allows performance engineers to insert calls into their code to name the current instances of these low-level abstractions.

Low-level abstraction range name 105 may be an enumeration (a list of named literal values) that lists identifiers for ranges of low-level abstractions. In an exemplary embodiment of the invention, low-level abstraction range name 105 may consist of, but is not limited to, the following exemplary values: “relative virtual address range”, and “modules in path”. Further, in an exemplary embodiment of the invention, the low-level abstraction range names 105 may not be data elements within the model data structure, but may instead be a set of fixed constants used to define other elements within the data structure.

Low-level instance range identifier 106 may be a data element that identifies a range of instances of a low-level abstraction in terms of the way that abstraction is identified by the compiler, OS, or MRTE. Examples of Low-level instance range identifiers 106 may include, but are not limited to: (modules in path) “C:Program Files\My Application”, and (relative virtual address range) “0x4310” “0x5220.” In an exemplary embodiment of the invention, low-level instance identifiers 106 may be used within high-level instance definitions 109 discussed below.

High-level abstraction names 107 may be a set of strings that name the high level abstractions used in the model. Examples of high-level abstraction names 107 may include, but are not limited to: “application”, “layer”, “subsystem”, “framework”, “component”, “virtual machine”, “operating system”, and “tier”.

High-level instance name 108 may be a short string that names an instance of a high-level abstraction. Examples of high-level instance names 108 may include: (tier) “database”, (layer) “presentation”, (subsystem) “rendering”. In an exemplary embodiment of the invention, high-level instance names 108 may be used within high-level instance definitions 109 discussed below.

High-level instance definitions 109 may define a set of mappings between a pair of the form (<High-level abstraction name> <High-level instance name>) and an algebraic expression whose operators may be the binary set operators “union” and “intersection”, for example, and whose operands may be pairs of one of the following forms: (<Low-level abstraction name> <Low-level instance name>), (<Low-level abstraction range name> <Low-level instance range identifier>), and (<High-level abstraction name> <High-level instance name>). Examples of high-level instance definitions 109 may include, but are not limited to: “(<operating system> <OS 101>) is defined by (<modules in path> <C:\os101>)”, “(<tier> <database>) is defined by (<node> <142.64.234.12>)”, “(<layer> <presentation>) is defined by ((<module> <presUI.dll>) union (<module> <presENG.dll>))”, and (<garbage collector> <J2SE JVM>) is defined by ((<function> <mark_sweep>), (<function>, <gc0>)).

Top-level instance list 109 may include a list of pairs of the form (<High-level abstraction name> <High-level instance name>) or (<Low-level abstraction name> <Low-level instance name>), for example, indicating the most important high-level and low-level instances to be used to generate top-level views of the profile data.

In an exemplary system according to the present invention, data structure instances, corresponding to model structure 100, may be generated by a performance tool developer (for models corresponding to widely-used software systems like specific operating systems and MRTE's), by a user, for example, via a visual model editor or modeling language (for models corresponding to application-specific software systems), and/or by the performance tool itself (for example by using algorithms for generating default models of the application and the software environment based on options that may be selected by the user). These data structure instances may be called “models”. In an exemplary embodiment of the present invention, the models may be stored on a disk or other machine-readable medium in a persistent “model library”.

FIG. 2 illustrates an exemplary system structure 200 for implementing high-level analysis of software performance according to an exemplary method according to an embodiment of the invention. System 200 may include data engine 201 and model mapping engine 202. Data engine 201 may operate within a performance tool (not shown) to support relational database queries from model mapping engine 202 (described below) for profile data 203 corresponding to relational expressions involving low-level instances. Data engine 202 may, for example, use compiler, OS, and/or MRTE mechanisms to identify profile data corresponding to low-level instances.

Model mapping engine 202 may operate within the performance tool and may be used, for example, by visualization and/or expert system components to obtain lists of top-level instances and to perform queries on profile data 203. In an exemplary embodiment of the invention, input into model mapping engine 202 may be a list of names of the selected models. Further, in an exemplary embodiment of the invention, model mapping engine 202 may support several different types of queries including, but not limited to, top-level instance queries, high-level instance structure queries, high-level instance flattening queries, and profile data queries.

A top-level instances query may query for the list of top-level instances in the selected models. Model mapping engine 202 may use a model library 204 to return a set of instances consisting of the union of all the top-level instances in each of the top-level instance lists in each of the selected models.

A high-level instance structure query may query for the structure of a given high-level instance. Model mapping engine 202 may find the definition of the high-level instance within the set of selected models and may return a data structure corresponding to the algebraic expression that defines that instance.

A high-level instance flattening query may query for the structure of a given high-level instance in terms of low-level instances. Model mapping engine 202 may find the definition of the high-level instance within the set of selected models, and for each high-level instance in that definition, may recursively perform another flattening query on that instance, and may substitute the result in the original definition.

A profile data query may query for the profile data corresponding to a given high-level or low-level instance. If the instance is a low-level instance, for example, model mapping engine 202 may pass the query to data engine 201. If the instance is a high-level instance, for example, model mapping engine 202 may perform a flattening query on the high-level instance to translate it into an expression based on low-level instances, and may then use that expression to query data engine 201 for profile data 203.

System 200 may also include a sampling-based profile visualization system 205 that may be capable of supporting, for example, process, thread, module, and hotspot (source file, class, function, and relative virtual address) views that may be used to progressively view, filter and partition the data by the corresponding low-level units of abstraction. In addition, system 200 may include an architecture view 206 as the default view for sampling-based profile data (see discussion below relating to FIG. 11 for further details). Architecture view 206 may give a high-level perspective on profile data 203 based on the top-level instances defined in the selected models, and may allow “drilling down” (partitioning/filtering) into other views based on these high-level instances. Architecture view 206 may also obtain the list of top-level instances from model mapping engine 202 via a top-level instances query, may obtain profile data 203 corresponding to these instances via profile data queries, and may display the results. In an exemplary embodiment of the invention, architecture view 206 may enable a user to expand any high-level instances in this view to see the profile data for its component instances, via an expandable tree-type user interface control. When the user requests expansion of a high-level instance, for example, architecture view may get the structure of the high-level instance from model mapping engine 202 via a high-level instance structure query.

System 200 may also include a call graph profile visualization system 207 that may be capable of supporting a hierarchical view 208 in which the user may first be presented with a summary of the call graph profile data in terms of only the top-level instances defined in the selected models. At any time when viewing the data in this mode, the user may be able expand any node that corresponds to a high-level instance to redraw the graph (and revise the profile data) to show component instances inside an expanded outline of a high-level instance.

System 200 may also include expert system 209, which may operate within the performance tool and may automatically interpret profile data 203 in terms of high-level instances defined in selected models. In expert system 209, knowledge may be encoded in terms of high-level abstractions to give high level advice 210 to a user in the context of these abstractions, for example, on system and application changes that may improve performance. For example, an expert system knowledge base may contain a rule such as, but not limited to the following: “if ((<time> for <application>) divided by (<total time>)) is low, then give the advice “Consider using call graph profiling to find the application code that is invoking code outside the application, and look for optimizations there.”

System 200 may also include model library browser 211, model editor 212, model generator 213, and model set 214. In an exemplary embodiment of the invention, a user may use model library browser 211 to create, edit, and automatically generate models using model generator 213. The may also automatically select a model set 214 for analysis. Model editor 212 may be used to manually edit a model, for example, when the structure of the application being analyzed is fairly stable.

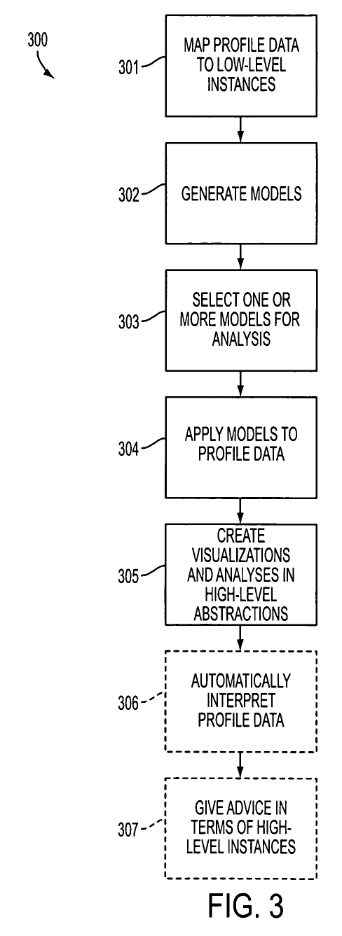

System 200 may be used for carrying out exemplary methods according to the present invention. FIG. 3 illustrates flow chart 300 for mapping profile data into high-level abstractions. When collecting and/or analyzing performance data, in block 301, the performance tool (not shown) may map profile data 203 to low-level instances using mechanisms available through compilers, OS's, and MRTE's, for example. In block 302, the performance tool may generate some models “on the fly”, for example, at run time during performance data collection. In block 303, the performance tool may select from model library 204, for example, a set of one or more models 214 appropriate for the software environment being analyzed, possibly with input from the user. In block 304, the performance tool may apply the models to the profile data 203 to map the data from the low-level instances to the high-level instances defined in the models. In block 305, both the low-level and the high-level instances and abstractions may be used by the performance tool to create visualizations and analyses of the profile data 203.

In an exemplary embodiment of the invention, in block 306, the high-level abstractions may be used within the knowledge-bases of expert system 209 to automatically interpret the profile data 203 in terms of the high-level abstractions. In block 307, the performance analyzer may give advice 210 to the user in the context of high-level instances on system and application changes that may improve performance.

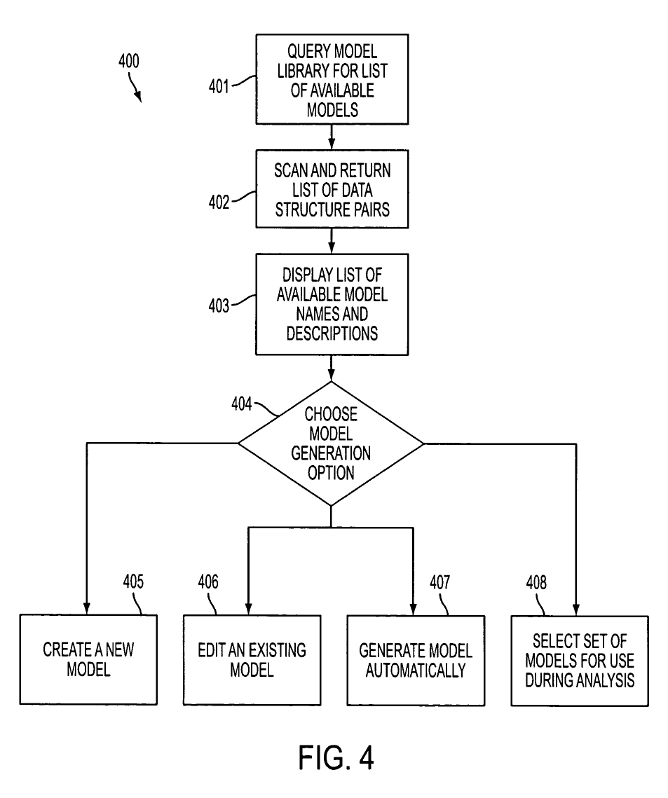

As discussed above, the user may use model library browser 211 to create, edit, automatically generate models, and/or select a set of models to use for analysis. The user may want to edit a model, for example, when the structure of the application being analyzed is fairly stable, and when using intuititvely-named application components is important to the user, for example. FIG. 4 depicts flow chart 400, which illustrates an exemplary method for creating, generating, and selecting models according to the present invention.

Once model library browser 211 is running, in block 401, model library browser may query model library 204 for a list of available models. In block 402, model library 204 may scan through available models and may return a list of data structure pairs (e.g., <model name>, <model description>), one pair for each model in the library. In block 403, model library browser 211 may display the list of available model names and their descriptions. In block 404, the user may use model library browser 211 to choose a model generation option. If the user chooses to create a new model, flow chart 400 may proceed to block 405. If the user chooses to edit an existing model, flow chart 400 may proceed to block 406. If the user chooses to generate a model automatically, flow chart 400 may proceed to block 407. If the user chooses to select a set of models to use for analyzing performance data, flow chart 400 may proceed to block 408.

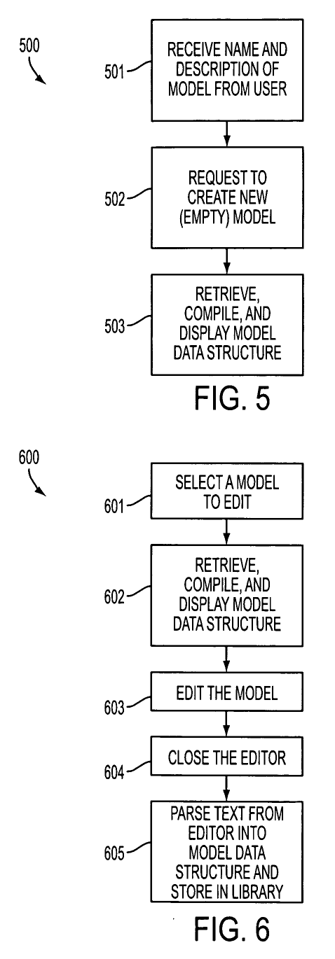

In block 405, model library browser 211 may create a new model. FIG. 5 depicts flow chart 500, which illustrates an exemplary method for creating a new model according to an embodiment of the invention. To create a new model, in block 501, model library browser 211 may receive as input the name and description of the model from user. In block 502, model library browser 211 may request model library 204 to create a new (empty) model. In block 503, model library browser 211 may retrieve the model data structure from model library 204 and may use compiler technology, as would be understood by a person having ordinary skill in the art, to display the model data structure.

In block 406, as is shown in FIG. 4, the user may choose to edit an existing model. FIG. 6 depicts flow chart 600, which illustrates an exemplary method for editing an existing model according to an embodiment of the invention. In block 601, the user may use model library browser 211 to select a model to edit from the list in model library browser 211. In block 602, model library browser 211 may retrieve the model data structure from model library 204 and may use compiler technology, as would be understood by a person having ordinary skill in the art, to display the model data structure as text in the editor. In block 603, the user may use the editor to edit the model. In an exemplary embodiment of the invention, the editor may represent the model using a text-based representation and serve as a simple text editor. In block 604, the user may close the editor. In block 605, the editor may use compiler technology, as would be understood by a person having ordinary skill in the art, to parse the text from the editor into a model data structure, and may store the model data structure in the library.

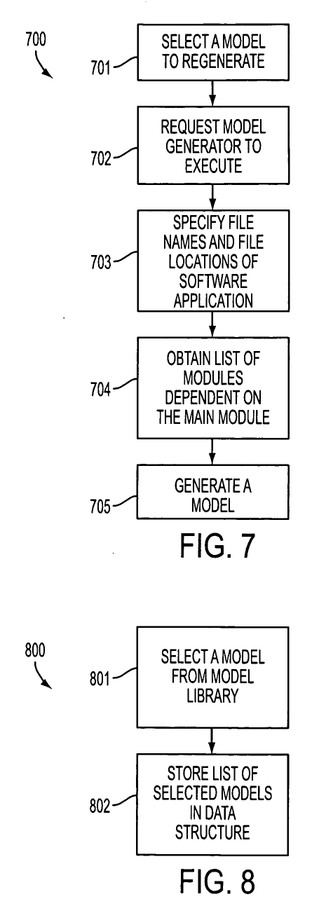

In block 407, as is shown in FIG. 4, the user may choose to automatically generate a model. FIG. 7 depicts flow chart 700, which illustrates an exemplary method for automatically generating a model according to an embodiment of the present invention. In block 701, the user may use model library browser 211 to select a model to re-generate from the list in the browser. Once the model is selected, model library browser 211 may request model generator 213 to execute in block 702. In block 703, the user may specify file names and file locations, for example, of the main modules, such as, e.g., executable files, jar files, or the like, that make up the software application that is to be analyzed. In block 704, model generator 213 may use well-known mechanisms (based on accessing “debug” information via compiler or MRTE technology, for example) to obtain a list of modules dependent on the main modules, and (where available) may obtain a list of source file names and source file locations for both the main and the dependent modules. Based on the above information, in block 705, model generator 213 may generate a model. In an exemplary embodiment of the invention, the model generated by model generator 213 may be a tree having, for example, the application at the root, the main modules as children of the application, the main module source folders as children of each main module (if source files are available), the source folder's source files as children of each source folder, each main module's dependent modules as children of each main module (if dependent modules exist), each dependent module's source folders as children of each dependent module (if source files are available), and each source folder's source files as children of each source folder (if source files are available). Embodiments of the invention, however, are not limited to this example.

In block 408, the user may use model library browser 211 to select a model or set of models to use for analyzing performance data. FIG. 8 depicts flow chart 800, which illustrates an exemplary method for selecting a model or set of models to be used for analyzing performance data, according to an embodiment of the invention. In block 801, the user may select a model or set of models from model library 204. Once the user has selected the model or set of models, in block 802, model library browser 211 may store a list of the selected models in a data structure.

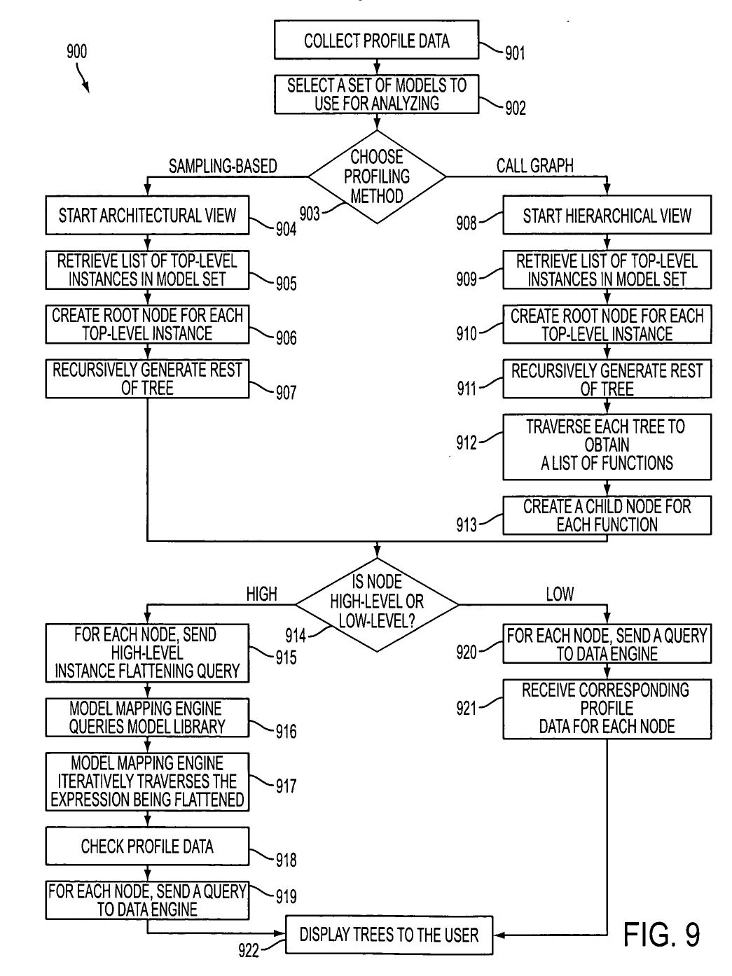

To analyze performance data, a user may use hierarchical models of the software structure. FIG. 9 depicts flow chart 900, which illustrates an exemplary method for using architecture view 206 to analyze and/or view sampling-based profile data and hierarchical view 208 to analyze and/or view call graph profile data, according to an embodiment of the invention. In block 901, profile data may be collected. In an exemplary embodiment of the invention, to collect the profile data, the user may use API calls within an application to name particular units of control (processes, threads, etc). If so, when collecting profile data, the performance tool may create a mapping between the names provided by the user via the API calls, to unique identifiers (process ID's, thread ID's, etc.) for the units of control. The tool may store this mapping with the profile data, to be used, for example, when interpreting models later. In block 902, the user may select a set of models to use for analyzing performance data. In block 903, the user may choose which type of performance data the user would like to use. If the user chooses to analyze sampling-based performance data, flow chart 900 may proceed to block 904. If the user chooses to analyze call graph data, flow chart 900 may proceed to block 908.

In block 904, architecture view 206 may be opened. For a more detailed discussion of architecture view 206, please refer to the discussion below regarding FIG. 11. Once architecture view 206 is opened, in block 905, architecture view 206 may retrieve a list of top-level instances in the model set from model mapping engine 202. In block 906, architecture view 206 may create a root node for each top-level instance. In block 907, architecture view 206 may recursively generate the rest of the tree. To recursively generate the rest of the tree, for each high-level instance in the tree, architecture view 206 may send a “high-level instance structure query” to model mapping engine 202 to get a data structure corresponding to an algebraic expression that defines that instance. Architecture view 206 may then create a child node corresponding to each instance in the expression. For each child node that corresponds to a high-level instance, architecture view 206 may recursively generate sub-children in the same way. The recursion may end at nodes corresponding to low level instances, which would then be the leaves of the tree.

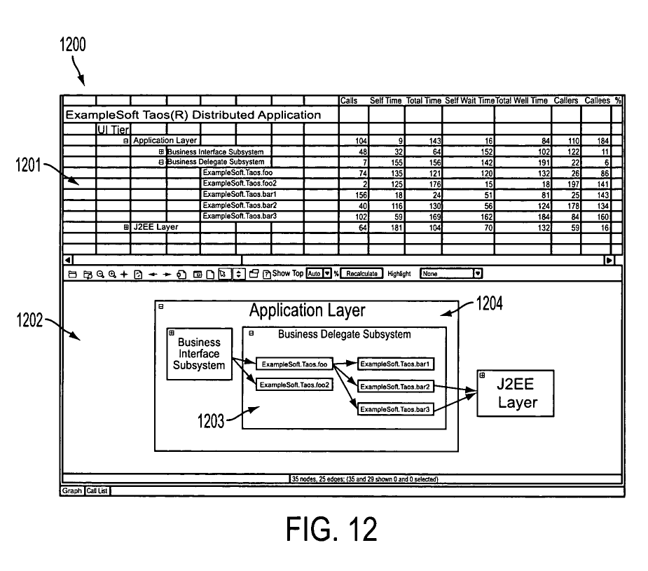

If the user chooses to analyze call graph data, in block 908, hierarchical view 208 may be opened. For a more detailed discussion of hierarchical view 208, please refer to the discussion below regarding FIG. 12. Once hierarchical view 208 is opened, in block 909, hierarchical view 208 may retrieve a list of top-level instances in the model set from model mapping engine 202 . In block 910, hierarchical view 208 may create a root node for each top-level instance. In block 911, hierarchical view 208 may recursively generate the rest of the tree. To recursively generate the rest of the tree, for each high-level instance in the tree, hierarchical view 208 may send a “high-level instance structure query” to model mapping engine 202 to get a data structure corresponding to an algebraic expression that defines that instance. Hierarchical view 208 may then create a child node corresponding to each instance in the expression. For each child node that corresponds to a high-level instance, hierarchical view 208 may recursively generate sub-children in the same way. The recursion may end at nodes corresponding to low level instances, which are would then be leaves of the tree.

In block 912, hierarchical view 208 may then traverse the leaves of the tree. Each leaf may correspond to a low-level instance (e.g., a module, source file, etc.). For each leaf, in block 913, hierarchical view 208 may use, for example, compiler and/or MRTE technology, as would be understood by a person having ordinary skill in the art, to get a list of functions corresponding to that low-level instance and may create a child node for each function.

In block 914, either architecture view 206 or hierarchical view 208 may traverse all the nodes of the tree, may associate profile data with each node, and may determine each node type. If the node is a high-level node, flow chart 900 may then proceed to block 915. If the node is a low-level node, flow chart 900 may then proceed to block 919.

In block 915, for each node corresponding to a high-level instance, the view may send a “high-level instance flattening query” to model mapping engine 202 to get an expression representing the structure of the high-level instance in terms of low-level instances. In block 916, model mapping engine 202 may query model library 204 to find an expression that defines the high-level instance, within the a of selected models. In block 917, model mapping engine 202 may iteratively traverse the expression being flattened. Every time model mapping engine 202 finds a high-level instance within the expression, model mapping engine 202 may query model library 204 to find an expression defining that high-level instance, and may substitute that definition in the expression being flattened. The iteration may continue until there are no more high-level instances in the expression being flattened—only low-level instances. In block 918, model mapping engine 202 may check in the profile data set 203 to see whether the user used API calls within the application to name particular units of control (processes, threads, etc.). If the user used API calls, the performance tool may use a mapping stored in profile data 203 to replace the instance names for the units of control with the corresponding unique identifiers, which the performance tool obtains via the mapping. Because the resulting expression represents unions and intersections of profile data corresponding to low-level instances, in block 919, the view may use relational database techniques, as would be understood by a person having ordinary skill in the art, to send a query to data engine 201 to get the profile data corresponding to the node.

If the node is a low-level node, in block 920, for each node corresponding to a low-level instance, the view may send a query to data engine 201 to get the profile data corresponding to that node. In block 921, the view may receive the corresponding profile data for each node.

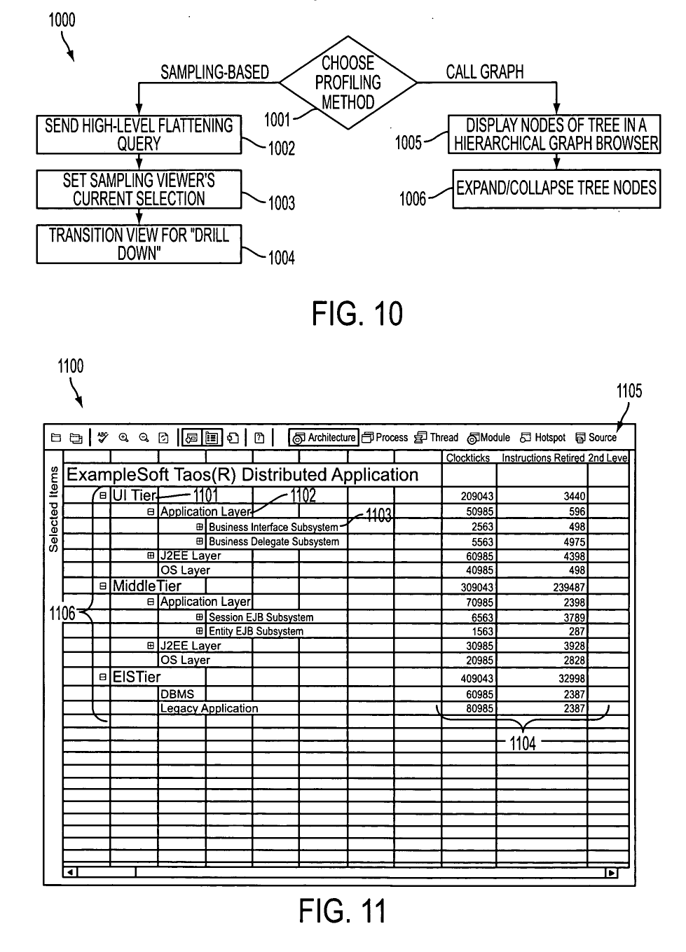

In block 921, either architecture view 206 or hierarchical view 208 may display the trees to the user. FIG. 10 depicts flow chart 1000, which illustrates an exemplary method for displaying the analyzed performance data to the user according to an embodiment of the invention. The view may display the trees and their associated profile data in a “tree browser” environment (as is shown in FIG. 11 and the top half of FIG. 12), that allows the user to expand/collapse tree nodes, using well-known user interface techniques.

In block 1001, the user may choose a profiling method. If the user chooses sampling-based profile data, flow chart 1000 may proceed to block 1001. If the user chooses call graph profile data, flow chart 1000 may proceed to block 1005.

In block 1001, architecture view 206 may display sampling-based profile data, and the user may also select a set of nodes in the view and may request a “drill down” to another sampling view. In block 1002, architecture view 206 may then send a “high-level instance flattening query” to model mapping engine 202 to get expressions representing the structure of the high-level instances in terms of low-level instances (as described above). In block 1003, architecture view 206 may set the sampling viewer's “current selection” to filter the profile data based on unions of these expressions. In block 1004, architecture view 206 may transition architecture view 206 to the new view that the user selected for drill-down.

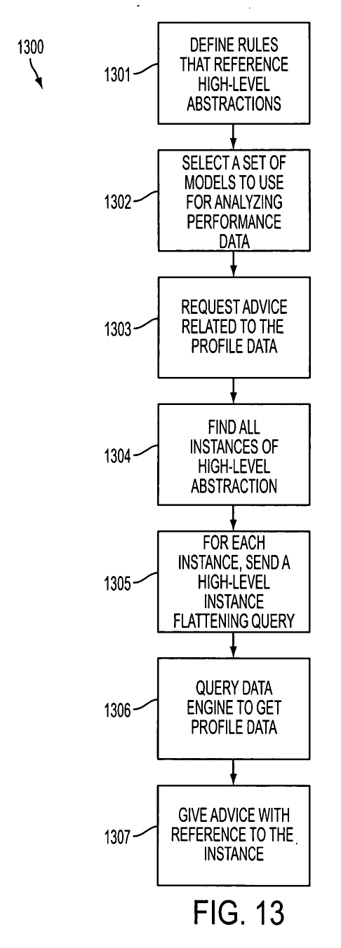

In block 1005, hierarchical view 20 may display the nodes of the trees in a “hierarchical graph browser” control (see the lower half of FIG. 13, for example), using user interface techniques, as would be understood be a person having ordinary skill in the art. In block 1006, the user may expand/collapse tree nodes. When the user expands or collapses a node, the children may be shown (as new nodes in the graph, nested within the parent node), or hidden, respectively. Also, each time the user expands or collapses a node, the view may traverse each pair of visible nodes and may draw an edge between the pair if there is a caller/callee relationship for that pair (based on the profile data for that pair).

FIG. 11 depicts an exemplary screen shot of architecture view 206 according to the invention. Architecture view 206 may include tree 1106 that may have, for example, tiers 1101, layers 1102, and subsystems 1103. Architecture view 206 may also have performance characteristics 1104 and menu bar 1105 for navigating through architecture view 206. Layers 1102 and subsystems 1103 may be expanded and/or collapsed to show or hide details, respectively. Using architecture view 206, the user may browse the architecture of a large distributed application, may understand its high-level performance characteristics 1104, and select/drill-down on particular parts of the application (drilling down may send the user back into a traditional sampling view—process, module, etc.). Additionally, users may create their own custom software models (defining high-level tiers, layers, subsystems, etc., in terms of the nodes, processes, modules, etc. they contain) using a simple editor, for example. Architecture view 206 may be generated using a customized software model of the user's application, which may be created by the user. The use of a custom software model may make it possible for the user to easily browse and comprehend the performance of large distributed software systems, to compare the performance of various parts of the system, and to drill-down to the traditional sampling views to get more details.

FIG. 12 depicts screen shot 1200, which illustrates an exemplary hierarchical view 208 according to an embodiment of the invention. FIG. 12 may include performance data portion 1201 for displaying call graph performance data and visual graph portion 1202 for displaying a call graph visualization. In FIG. 12, lower-level instances 1203 may be nested within higher-level instances 1204 in the call graph visualization. As in the sampling architecture view 206, instances may be expanded and collapsed to show and hide the more-detailed instances they contain, in both the call graph visualization and the table above.

In an exemplary embodiment of the invention, system 200 may have a module 210 for giving high level advice relating to the software application. FIG. 13 depicts flow chart 1300, which illustrates an exemplary method for giving high-level advice according to the invention. In block 1301, an expert system knowledge base developer may define rules that reference single high-level abstractions. For example, the single high-level abstraction “application” may be used in the following rule:
“if ((<time> for <application>) divided by (<total time>)) is low, then give the advice “Consider using call graph profiling to find the application code that is invoking code outside the application, and look for optimizations there.”

In block 1302, the user may select a set of models to use for analyzing performance data. In block 1303, the user may request advice related to a set of profile data 203. In block 1304, for each rule that references a single high-level abstraction, expert system 209 may use model library 204 to find all instances of a high-level abstraction in a set of models chosen by the user. In block 1305, expert system 209 may then send a “high-level instance flattening query” to model mapping engine 202 to get an expression representing the structure of the high-level instance terms of low-level instances (as described above). In block 1306 expert system 209 may then use relational database techniques, as would be understood by a person having ordinary skill in the art, to send a query to data engine 201 to get the profile data corresponding to the instance (as described above). In block 1307, expert system 209 may use the profile data for the instance to evaluate the predicate within the rule and to give the associated advice with reference to the instance, if the predicate evaluates to “true”, for example.

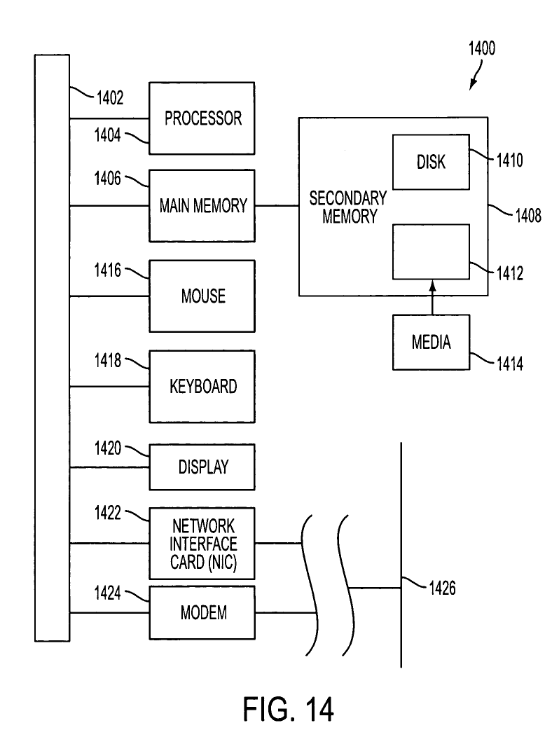

FIG. 14 depicts an exemplary embodiment of a computer and/or communications system as may be used for several components of the programming service offer presentment system and instantaneous activation system in an exemplary embodiment of the present invention. FIG. 4 depicts an exemplary embodiment of a computer 1400 as may be used for several computing devices in the present invention. Computer 1400 may include, but is not limited to: e.g., any computer device, or communications device including, e.g., a personal computer (PC), a workstation, a mobile device, a phone, a handheld PC, a personal digital assistant (PDA), a thin client, a fat client, an network appliance, an Internet browser, a paging, or alert device, a television, an interactive television, a receiver, a tuner, a high definition (HD) television, an HD receiver, a video-on-demand (VOD) system, a server, or other device. Computer 1400, in an exemplary embodiment, may comprise a central processing unit (CPU) or processor 1404, which may be coupled to a bus 1402. Processor 1404 may, e.g., access main memory 1406 via bus 1402. Computer 1400 may be coupled to an Input/Output (I/O) subsystem such as, e.g., a network interface card (NIC) 1422, or a modem 1424 for access to network 1426. Computer 1400 may also be coupled to a secondary memory 1408 directly via bus 1402, or via main memory 1406, for example. Secondary memory 1408 may include, e.g., a disk storage unit 1410 or other storage medium. Exemplary disk storage units 1410 may include, but are not limited to, a magnetic storage device such as, e.g., a hard disk, an optical storage device such as, e.g., a write once read many (WORM) drive, or a compact disc (CD), or a magneto optical device. Another type of secondary memory 1408 may include a removable disk storage device 1412, which can be used in conjunction with a removable storage medium 1414, such as, e.g. a CD-ROM, or a floppy diskette. In general, the disk storage unit 1410 may store an application program for operating the computer system referred to commonly as an operating system. The disk storage unit 1410 may also store documents of a database (not shown). The computer 1400 may interact with the I/O subsystems and disk storage unit 1410 via bus 1402. The bus 1402 may also be coupled to a display 1420 for output, and input devices such as, but not limited to, a keyboard 1418 and a mouse or other pointing/selection device 1416.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that the invention may be practiced otherwise than as specifically described.

1. A processing system comprising:
a data engine adapted to identify profile data corresponding to low-level instances of a software application;
a model library adapted to store at least one model, the at least one model having high-level instances;
a model mapping engine adapted to at least one of query the data engine to obtain a list of the high-level instances, query the profile data, and map the profile data to the high-level instances; and
a visualization system adapted to present the profile data in terms of the high-level instances.

2. The processing system of claim 1, wherein the visualization system is at least one of a sampling-based profile visualization system and a call graph profile visualization system.

3. The processing system of claim 2, wherein the profile data is sampling-based profile data and the sampling-based profile visualization system is adapted to present the sampling-based profile data via an architecture view.

4. The processing system of claim 2, wherein the profile data is call graph profile data and the call graph profile visualization system is adapted to present the call graph profile data via a hierarchical view.

5. The processing system of claim 1, further comprising:
an expert system adapted to provide high-level advice relating to the low-level instances of the software application.

6. The processing system of claim 1, further comprising:
a model library browser adapted to at least one of create, edit, automatically generate, and select the at least one model.

7. The processing system of claim 6, wherein the model library browser includes at least one of a model editor adapted to edit the at least one model, and a model generator adapted to generate the at least one model.

8. The processing system of claim 1, wherein the model mapping engine is adapted to perform at least one of a top-level instance query, a high-level instances structure query, a high-level instance flattening query, and a profile data query.

9. A method comprising:
mapping profile data of a software application to low-level instances of the software application;
performing at least one of generating and selecting at least one model appropriate for the software application, the at least one model having high-level abstractions;
applying the at least one model to the profile data to map the low-level instances to the high-level abstractions; and
creating visualizations of the high-level abstractions.

10. The method of claim 9, further comprising:
providing advice to improve performance of the software application in terms of the high-level abstractions.

11. The method of claim 9, wherein said performing at least one of generating and selecting comprises at least one of creating a new model, editing an existing model, and automatically generating a model.

12. A method comprising:
collecting profile data of a software application;
selecting at least one model to analyze the profile data, the at least one model having top-level instances;
retrieving the top-level instances;
creating root node for each top level instance;
generating a hierarchical model for each root node, the hierarchical model having a plurality of child node
associating the profile data with the plurality of child nodes;
displaying the hierarchical models.

13. The method of claim 12, wherein the generating is done recursively.

14. The method of claim 12, further comprising:
traversing each hierarchical model to obtain a list of functions within the software application; and
creating a child node for each function.

15. The method of claim 12, wherein the profile data is sampling-based profile data.

16. The method of claim 12,wherein the profile data is call graph profile data.

17. A machine accessible medium containing program instructions that, when executed by a processor, cause the processor to:
map profile data of a software application to low-level instances of the software application;
at least one of generate and select at least one model appropriate for the software application, the at least one model having high-level abstractions;
apply the at least one model to the profile data to map the low-level instances to the high-level abstractions; and
create visualizations of the high-level abstractions.

18. The machine accessible medium according to claim 17, containing further program instructions that, when executed by a processor, cause the processor to:
provide advice to improve performance of the software application in terms of the high-level abstractions.

19. The machine accessible medium according to claim 17, containing further program instructions that, when executed by a processor, cause the processor to:
at least one of create a new model, edit an existing model, and automatically generate a model.

20. A machine accessible medium containing program instructions that, when executed by a processor, cause the processor to:
collect profile data of a software application;
select at least one model to analyze the profile data, the at least one model having top-level instances;
retrieve the top-level instances;
create root node for each top level instance;
generate a hierarchical model for each root node, the hierarchical model having a plurality of child node
associate the profile data with the plurality of child nodes;
display the hierarchical models.

21. The machine accessible medium according to claim 20, containing further program instructions that, when executed by a processor, cause the processor to:
generate the hierarchical model for each node recursively.

22. The machine accessible medium according to claim 20, wherein the computer readable memory contains further program instructions that, when executed by a processor, cause the processor to:
traverse each hierarchical model to obtain a list of functions within the software application; and
create a child node for each function.

23. The machine accessible medium according to claim 20, wherein the profile data is sampling-based profile data.

24. The machine accessible medium according to claim 20, wherein the profile data is call graph profile data.
